(19) United States
(12) Patent Application Publication
(10) Pub. No.: US 2024/0092325 A1
(43) Pub. Date: Mar. 21, 2024

(54) Redundant Vehicle Braking System and its Electronic Control Unit and Control Method Thereof

(71) Applicant: Robert Bosch GmbH, Stuttgart (DE)

(72) Inventors: Renrui WANG, Suzhou (CN); Yichen JIN, Suzhou (CN); Zhe HOU, Suzhou (CN)

(21) Appl. No.: 18/464,535

(22) Filed: Sep. 11, 2023

(30) Foreign Application Priority Data
Sep. 16, 2022 (CN) 2022 1113 2960.4

(51) Int. Cl. B60T 8/88; B60T 8/172; B60T 8/1755; B60T 8/32; B60T 8/92; B60T 13/62; B60T 13/68; B60T 17/22

(52) U.S. Cl. CPC B60T 8/885; B60T 8/172; B60T 8/17551; B60T 8/326; B60T 8/92; B60T 13/62; B60T 13/686; B60T 17/22; B60T 2201/03; B60T 2220/04; B60T 2250/04; B60T 2270/304; B60T 2270/402; B60T 2270/406; B60T 2270/413

(57) ABSTRACT

A redundant vehicle braking system and its electronic control unit and control method thereof is disclosed. The redundant braking system is coupled to the main braking system of the vehicle. The electronic control unit comprises: a receiving module configured to receive a status signal indicating the status of the main braking system and a sensor signal indicating a driver input condition to the brake pedal and a vehicle speed condition; an activation module configured to activate the braking assist function of the redundant braking system when it is judged that the main braking system has entered a mechanical backup state based on the status signal; and a braking assist module configured to, upon activation of the braking assist function, execute a corresponding one of a plurality of braking assist modes based on the sensor signal, wherein the plurality of braking assist modes comprise: a standby mode, a first-assist adjustable mode, a second-assist adjustable mode, and a braking pressure holding mode.

This application claims priority under 35 U.S.C. § 119 to patent application no. CN 2022 1113 2960.4, filed on Sep. 16, 2022 in China, the disclosure of which is incorporated herein by reference in its entirety.

The present disclosure relates to the technical field of vehicle braking, in particular to a redundant vehicle braking system and its electronic control unit and control method, and to a corresponding machine-readable storage medium.

### BACKGROUND

Automotive safety refers to the performance of a vehicle to avoid accidents and ensure the safety of pedestrians and occupants. Automotive safety includes passive safety such as airbags and seat belts, and active safety such as automatic emergency braking. The performance of a vehicle's braking system (sometimes referred to as brakes) is an important safety indicator that characterizes a vehicle's active security.

With the development of autonomous driving, higher requirements have been put forward for the active safety of vehicles. In this regard, a solution has been proposed to set up two sets of braking systems on the vehicle, namely, to set up the main braking system and the redundant braking system as a backup in case of braking system failure. This redundant backup braking system can provide braking assistance for self-driving vehicles in the event of failure of the main braking system, so it can greatly improve the active safety of these vehicles. However, the existing redundant backup braking system has many design schemes for the use scenarios of autonomous driving, and the demand for braking assistance in the driver's driving mode is not fully considered. For example, in the event that the main braking system fails and the vehicle is in driver-driven mode, the existing redundant backup braking system cannot provide adequate braking power assist.

### SUMMARY

In this context, the present disclosure aims to provide an improved technical solution capable of, when the vehicle is in driver-driven mode, in the event of failure of the main braking system, for different driver inputs to the brake pedal and different speed conditions, thus providing a corresponding one of the plurality of the braking assist modes, and providing accurate braking assist to further enhance the active safety of the vehicle.

According to one aspect of the present disclosure, an electronic control unit for a redundant braking system of a vehicle is provided, the redundant braking system being coupled to a main braking system of the vehicle, and the electronic control unit comprising: a receiving module configured to receive a status signal indicating a status of the main braking system and a sensor signal indicating a driver input condition to the brake pedal and a vehicle speed condition; an activation module configured to activate the braking assist function of the redundant braking system when it is determined that the main braking system has entered a mechanical backup state based on the status signal; and a braking assist module storing a plurality of braking assist modes for achieving the assist function, the braking assist module configured to determine and execute a corresponding one of the plurality of braking assist modes based on the sensor signal after the braking assist function is activated, and the assist module further configured to switch braking assist modes among a plurality of braking assist modes based on changes in driver input to brake pedal and changes in vehicle speed, wherein the plurality of braking assist modes comprise: a standby mode, a first-assist adjustable mode, a second-assist adjustable mode, and a braking pressure holding mode.

According to another aspect of the present disclosure, a redundant braking system for a vehicle is provided, comprising: two braking circuits configured to be fluidly connected to the two brake circuits of the main braking system of the vehicle, respectively; four valves, connected between the main brake cylinder of the main braking system and the four brake wheel cylinders of the vehicle; a motor configured to generate braking assist for pumping brake fluid in the main brake cylinder into part or all of the four brake wheel cylinders; and an electronic control unit as described above for electrically operating the four valves and the motor and performing the braking assist function when the main braking system enters a mechanical backup state.

According to another aspect of the present disclosure, a method for controlling a redundant braking system for a vehicle is provided, optionally, the method being performed by an electronic control unit as described above or a redundant braking system as described above, the method comprising: receiving a status signal indicating a status of the main braking system of the vehicle and a sensor signal indicating a condition of driver input to the brake pedal and a vehicle speed condition; activating the braking assist function of the redundant braking system after determining that the main braking system enters a mechanical backup state based on the status signal; determining to execute a corresponding one of a plurality of braking assist modes based on the sensor signal after the braking assist function is activated; and switching the braking assist mode among the plurality of braking assist modes according to the changes in the driver's input to the brake pedal and the changes in the vehicle speed; specifically, the plurality of braking assist modes comprise: a standby mode, a first-assist adjustable mode, a second-assist adjustable mode, and a braking pressure holding mode.

According to another aspect of the present disclosure, a machine-readable storage medium is provided, storing executable instructions that, when executed, cause one or more processors to perform the control method described above.

A summary of the principal aspects of the present disclosure is given above in order to enable a basic understanding of these aspects. This summary is not intended to limit the scope of any or all aspects of the present disclosure. The purpose of this summary is to give some implementations of these aspects in a simplified form, as a preface to the detailed description to be given later.

### BRIEF DESCRIPTION OF THE DRAWINGS

The technical aspects of the present disclosure will become more apparent from the following detailed description taken in conjunction with the attached drawings. It should be understood that these drawings are for illustrative purposes only and are not intended to limit the scope of the present disclosure.

FIG. 1 is a schematic diagram of a redundant braking system according to one embodiment of the present disclosure.

FIG. 2 is a schematic block diagram of an electronic control unit for the redundant braking system of FIG. 1 in accordance with one embodiment of the present disclosure.

FIG. 3 is a flowchart of a braking assist control process implemented by the electronic control unit of FIG. 2, according to one embodiment of the present disclosure.

FIG. 4 schematically illustrates a braking assist model according to one embodiment of the present disclosure.

FIG. 5 is an exemplary graph used for the braking assist control process in FIG. 3.

FIG. 6 schematically shows an example of an adjustable assist amplification coefficient.

FIG. 7 is another graph of the braking assist control process used in FIG. 3 FIG. 8 is a flowchart of a control method for a redundant braking system for a vehicle, according to one embodiment of the present disclosure.

### DETAILED DESCRIPTION

Examples of the present disclosure relate to a solution for providing braking assistance by a redundant braking system as a backup system to the main braking system when the vehicle is in driver-driven mode.

Hereinafter, specific embodiments of the present disclosure will be described in conjunction with the attached drawings.

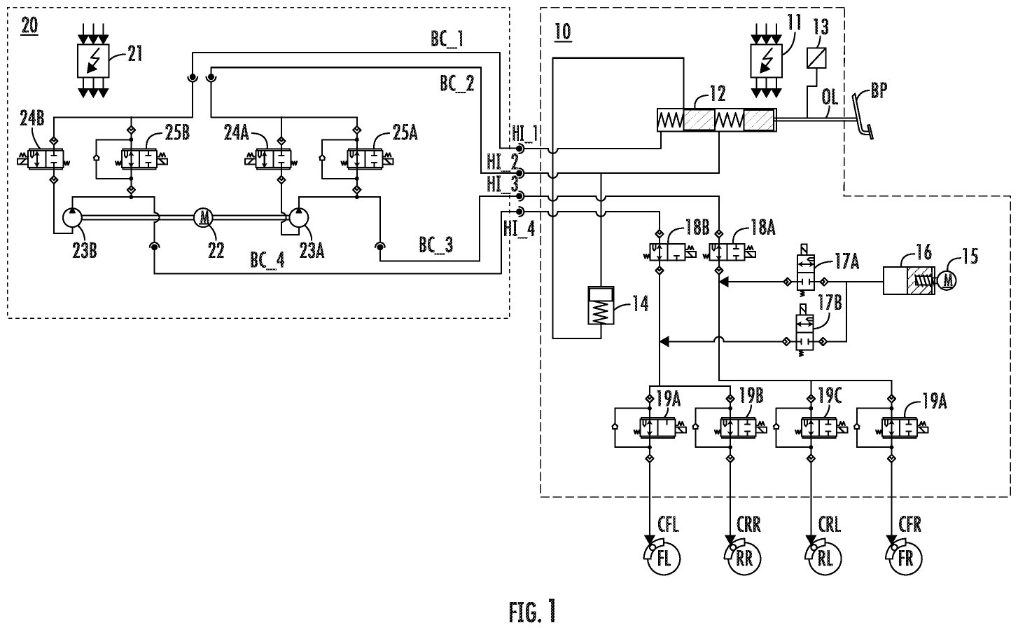

FIG. 1 schematically illustrates a redundant braking system 20 of a vehicle (not shown) in accordance with one embodiment of the present disclosure, hydraulically coupled to the main braking system 10 of the vehicle. The main braking system 10 is, for example, an integrated power braking system.

Referring to FIG. 1, in one example, the redundant braking system 20 and the main braking system 10 may be hydraulically coupled in the following manner: Between the two braking systems 10 and 20, hydraulic interfaces HI_1-HI_4 are arranged so that the two braking systems are formed as structural units separated from each other in space. These hydraulic interfaces HI_1-HI_4 can be separated from each other. Two braking systems 10 and 20 are hydraulically coupled via these hydraulic interfaces HI_1-HI_4 and via four hydraulic lines BC_1-BC_4.

Continually referring to FIG. 1, the main braking system 10 comprises: the electronic control unit 11, the main brake cylinder 12, the stroke sensor 13, the pedal stroke simulator 14, the motor 15, the plunger 16, the plunger control valves 17A-17B, the circuit release valves 18A-18B, and the pressure forming valves 19A-19D.

The brake fluid is stored in the main brake cylinder 12 and is used for the fluid connection of the four brake wheel cylinders CFL, CRR, CRL, and CFR for the four wheels FL, RR, RL, and FR. The stroke sensor 13 is used for measuring the operating stroke of the joystick OL connected to the brake pedal (BP) and sending the measured stroke signal to the electronic control unit 11. The pedal stroke simulator 14 simulates the stroke of the brake pedal (BP) and sends the signal of the simulation results to the electronic control unit 11. The motor 15 operates the plunger 16 electronically. The motor 15 is capable of individually controlling each of the pressure forming valves 19A-19D so that the pressure of each brake cylinder can be individually controlled. It is understood that, for clarity, only the main components of the main braking system 10 are shown in FIG. 1. The main braking system 10 may also comprise other components not shown. For example, the main braking system 10 also includes four pressure reducing valves (i.e., outlet valves) corresponding to pressure forming valves 19A-19D.

When the main braking system 10 is in normal operation, i.e., under the normal braking assist function of the main braking system 10, the main braking system 10 implements the braking assist function via electronic control unit 11.

It should be noted that the present disclosure does not limit how the electronic control unit 11 of the main braking system 10 implements the braking assist function. Examples of the present disclosure relate to: when the braking assist function of the main braking system 10 fails and the vehicle is in driver-driven mode, how the electronic control unit 21 of the redundant braking system 20 performs the braking assist function. Continually referring to FIG. 1, the redundant braking system 20 comprises the electronic control unit 21; the motor 22; two pressure generators 23A and 23B; and four valves 24A, 24B, 25A, and 25B.

Two pressure generators 23A and 23B with two brake circuits BC3 and BC4 are fluidly connected, wherein the pressure generator 23A is fluidly connected to the brake circuit BC3 and the pressure generator 23B is fluidly connected to the brake circuit BC4. The two pressure generators 23A and 23B are respectively implemented as a piston pump, for example. The motor 22 generates braking assist for driving pressure generators 23A and 23B to pump brake fluid from the main brake cylinder 12 into brake wheel cylinders CFL, CRR, CRL, and CFR. Four valves 24A, 24B, 25A, 25B may include valves 24A and 25A fluidly connected to the brake circuit BC3 and valves 24B and 25B fluidly connected to the brake circuit BC4. Valves 24A and 25A may be implemented as high-pressure on-off valves capable of switching from the normal cut-off position to the through-flow position under the electrical control of the motor 22. Valves 25A and 25B may be implemented as changeover valves capable of being flow-through in the initial position and steplessly transitioning to the cut-off position under electrical operation of the motor 22. Thus, the changeover valves 25A and 25B function as throttling mechanisms that enable the setting of different braking pressures by the redundant braking system 20 to be effectuated by corresponding electrical manipulation, for example, by infinitely adjusting the flow cross-section of the lines fluidly connected to the changeover valves 25A and 25B.

It should be noted that “electronic control unit” in the claims refers to the electronic control unit 21 of the redundant braking system 20. “Motor” in the claim refers to the motor 22 of the redundant braking system 20.

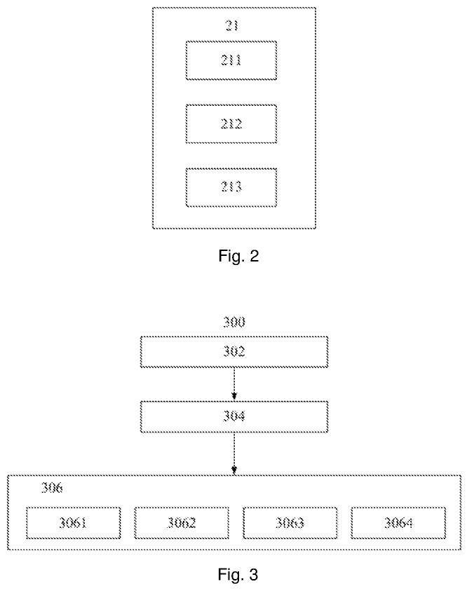

Referring to FIG. 2, the electronic control unit 21 may include the receiving module 211, the activation module 212, and the braking assist module 213. Understandably, the naming of these modules is functional and not intended to limit their implementation or physical location. For example, these modules can be implemented on the same chip or circuit, or on different chips or circuits.

The electronic control unit 21 and its modules may be implemented in hardware or software or in a combination of software and hardware. For parts implemented in hardware, they can be implemented via one or more application-specific integrated circuits (ASICs), digital signal processors (DSPs), data signal processing devices (DSPDs), programmable logic devices (PLDs), field programmable gate arrays (FPGAs), processors, controllers, microcontrollers, microprocessors, electronic units designed to perform their functions, or combinations thereof. For parts implemented in software, they can be implemented via microcode, program code, or code snippets, and also be stored in machine-readable storage media such as storage components.

In one example, the electronic control unit 21 is implemented to include a memory and a processor. The memory contains instructions that, when executed by the processor, cause the processor to execute the braking assist control method according to an example of the present disclosure.

FIG. 3 illustrates a braking assist control process according to one embodiment of the present disclosure 300. The braking assist control process 300 can be implemented by the electronic control unit 21 of the redundant braking system 20, so the relevant description above also applies here.

Referring to FIG. 3, in block 302, the receiving module 211 receives a status signal indicating the status of the main braking system 10 and a sensor signal indicating the driver's input to the brake pedal (BP) and the vehicle speed.

In one example, the receiving module 211 may receive the above-described status signals in the following manner. The main braking system 10 and the redundant braking system 20 are communicated via the onboard bus. The main braking system 10 performs a self-test of its status and sends a status signal indicating the detected status (for example, indicating that the braking assist function of the main braking system 10 is normal, abnormal, or invalid), to the onboard bus. Thus, the receiving module 211 of the redundant braking system 20 is capable of receiving a status signal indicating the status of the main braking system 20 from the onboard bus.

In one example, the receiving module 211 can receive a sensor signal indicating a driver's input to the brake pedal (BP) in the following manner. The driver's input to the brake pedal (BP) can be measured by the stroke sensor 13 described above and/or the pedal stroke simulator 14. In addition, the driver's input to the brake pedal (BP) can also be measured by other sensors, such as a force sensor (not shown) that measures the force exerted by the driver on the brake pedal (BP) (also referred to as “muscle force” or “driver force”). Furthermore, the measured sensor signal is sent to the onboard bus. Thus, the receiving module 211 of the redundant braking system 20 is capable of receiving a sensor signal from the onboard bus indicating the driver's input to the brake pedal (BP).

In one example, the receiving module 211 may receive a sensor signal indicating a vehicle speed in the following manner. The vehicle speed can be measured by the wheel speed sensor. The wheel speed sensor sends the measured sensor signal to the onboard bus. Thus, the receiving module 211 of the redundant braking system 20 is capable of receiving a sensor signal from the on-board bus indicating the vehicle speed.

In block 304, the activation module 212 determines whether to activate the braking assist function of the redundant braking system 20 based on the received status signal and/or sensor signal.

The activation module 212 activates the braking assist function of the redundant braking system 20 when determining that the main braking system 10 has entered a mechanical backup state based on the above-described status signal. “Mechanical backup state”, for example, occurs when the braking function of the main braking system fails. For example, based on the status signal of the main braking system 10, it is determined that the main braking system 10 has lost software control, or has lost power or has experienced hardware failure/degradation, and that the main braking system 10 has entered a mechanical backup state.

The activation module 212 does not activate the braking assist function of the redundant braking system 20 when at least one of the following conditions (1) and (2) is met.
(1) It is determined based on the above status signal that the braking assist function of the main braking system 10 is operating normally. For example, the main braking system 10 sends its status signal to the onboard bus at a predetermined frequency. Thus, when the main braking system 10 is operating normally, the activation module 212 is capable of receiving a sensor signal indicating that the main braking system 10 is operating normally at a predetermined time interval, and the activation module 212 determines that the braking assist function of the main braking system 10 is operating normally based on this.
(2) The vehicle speed is lower than the first vehicle speed threshold. The first vehicle speed threshold is predetermined, which can be a creeping vehicle speed or a vehicle speed obtained by adjusting the creeping vehicle speed appropriately. Here, the creeping speed refers to the coasting speed when the driver does not step on the accelerator pedal or brake pedal, assuming the vehicle is driving on flat ground. The first vehicle speed threshold can also be to be calibrated by actual vehicle experiments. For example, when the vehicle is heavier, the first vehicle speed threshold is calibrated lower; when the vehicle is relatively light, the first vehicle speed threshold is calibrated relatively high.

The first vehicle speed threshold should be understood as a low speed. At low speeds, even without braking assistance, driver force alone (i.e., the driver's muscle force) can help brake the vehicle safely. Therefore, when the vehicle speed is sufficiently low (i.e., below the first vehicle speed threshold), the braking assist function need not be activated.

In block 306, after the braking assist function of the redundant braking system 20 is activated, the braking assist module 213 determines, based on the received sensor signal, to execute the corresponding one of a plurality of braking assist modes. The plurality of braking assist modes is pre-determined and stored in the braking assist module 213. The plurality of braking assist modes include: standby mode (MODE_1), first-assist adjustable mode (MODE_2), second-assist adjustable mode (MODE_3), and braking pressure holding mode (MODE_4). The limitations of each braking assist mode and the following modes of operation in each braking assist mode are described below.

In one example, a braking assist model is stored in the braking assist module 213, which includes a plurality of braking assist modes described above and switching states between them. The braking assist module 213 uses this braking assist model to determine which braking assist mode to execute or to which braking assist mode to switch. These switching states correspond to changes in driver input to the brake pedal and changes in vehicle speed. These switching states comprise: two-way switching between the first-assist adjustable mode and the standby mode, the second-assist adjustable mode and the braking pressure holding mode, respectively; one-way switching from the braking pressure holding mode to the standby mode; one-way switching from the braking pressure holding mode to the second-assist adjustable mode; and one-way switching from the second-assist adjustable mode to the standby mode.

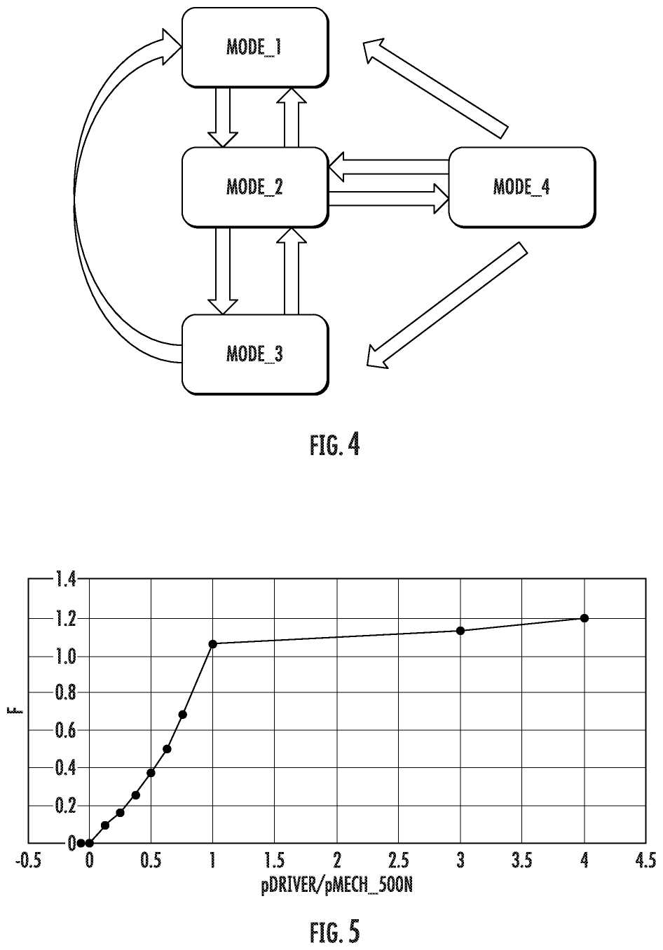

The braking assist model can be expressed via a state machine. FIG. 4 shows an example of the state machine. The directions of the “arrows” in FIG. 4 indicate the mode-switching directions. For example, referring to FIG. 4, the standby mode (MODE_1) is entered after the braking assist function of the redundant braking system 20 is activated. Next, it is switched from the standby mode (MODE_1) to the first-assist adjustable mode (MODE_2). Next, the vehicle switches from the first-assist adjustable mode (MODE_2) to the second-assist adjustable mode (MODE_3). Next, it returns from the standby mode (MODE_1) to the second-assist adjustable mode (MODE_3). The scenario for this example may be that after the braking assist function of the redundant braking system 20 is activated, the driver applies no force to the brake pedal (BP) (corresponding to “entering the standby mode”), and the driver then depresses the brake pedal (BP) (corresponding to “switching to the first-assist adjustable mode”), and then releases the brake pedal (corresponding to “switching to the second-assist adjustable mode”); finally, the driver exerts zero force on the brake pedal (BP) (corresponding to “returning to the standby mode”).

It should be understood that in addition to the state machine described above, the braking assist model may also be represented in other ways, such as a table containing the plurality of braking assist modes described above and the switching states therebetween.

Below, each braking assist mode and the braking assist operation performed by the braking assist module 213 in each braking assist mode will be described in details.

Referring to block 3061, in one example, the braking assist module 213 determines to execute the standby mode when the sensor signal indicates that the driver has no input to the brake pedal (BP). In the standby mode, the braking assist module 213 does not perform any assist operation. Here, the driver has no input to the brake pedal (BP) in a scenario such as: the driver does not press the brake pedal (BP).

Referring to block 3062, in one example, when the sensor signal indicates that the driver depresses the brake pedal (BP) and that the driver exerts a force on the brake pedal (BP) exceeding a pressure threshold, the braking assist module 213 determines to execute the first-assist adjustable mode. The pressure threshold is predetermined to accurately identify the driver's braking needs. For example, in order to distinguish the case where the driver's foot inadvertently taps the brake pedal (BP), the pressure threshold is used to determine whether the driver can accurately identify the brake pedal depression. Here, the pressure threshold should be understood as a very small pressure value, even zero or negative value.

In the first-assist adjustable mode, the braking assist operations performed by the braking assist unit 213 include the following steps: calculating the driver's desired braking pressure based on the sensor signal. For example, the driver's desired braking pressure is determined based on the operating stroke of the joystick OL or the driver force applied by the driver to the brake pedal. The present disclosure is not limited as to how a driver's desired braking pressure can be determined based on a sensor signal (e.g., a sensor signal indicating brake pedal stroke or driver force), so long as the examples that enable calculation of the desired braking pressure of the driver based on the sensor signal are applicable to the present disclosure. Next, an assist amplification coefficient corresponding to the driver's desired braking pressure is determined via the assist amplification coefficient curve so that the redundant braking system 20 performs vehicle braking assist according to the determined assist amplification coefficient. The assist amplification coefficient curve, which may be pre-drawn and stored in the braking assist unit 213, expresses the correspondence between the assist amplification coefficient and the driver's desired braking pressure.

FIG. 5 shows an example of the assist amplification coefficient curve where the horizontal coordinate represents the ratio between the driver's desired braking pressure and a fixed braking pressure (e.g., the corresponding braking pressure when the driver depresses the brake pedal with a muscle force of 500 N) (pDriver/pMech_500N), and the vertical coordinate represents the assist amplification coefficient; the curve represents the correspondence between the assist amplification coefficient and the ratio of the braking pressure mentioned above. Thus, the assist amplification coefficient corresponding to the driver's desired braking pressure can be obtained according to the assist amplification coefficient curve.

The assist amplification coefficient curve can be plotted in the following manner. First, the starting value of the assist amplification coefficient is set to zero, which corresponds to the driver's desired braking pressure (zero). Next, the assist amplification coefficient corresponding to the braking pressure is calculated based on the deceleration of the vehicle to be provided by a fixed braking pressure specified in the regulations relating to vehicle safety. For example, according to the regulations related to vehicle safety: on a road with a high adhesion coefficient, the driver applies a driver force of 500N to the brake pedal, and the vehicle should provide a deceleration of 6.44 m/s², resulting in an assist amplification coefficient at a brake pedal force of 500N, and giving a calibration point. Next, the assist amplification coefficient curve is obtained by drawing a curve between the zero-value point and the resulting calibration point so that the braking process can be a smooth process. The plotting of this curve can be realized based on actual vehicle experiments and/or model calculations. After obtaining the assist amplification coefficient curve, the driver's desired braking pressure can be determined based on the assist amplification coefficient determined by the curve.

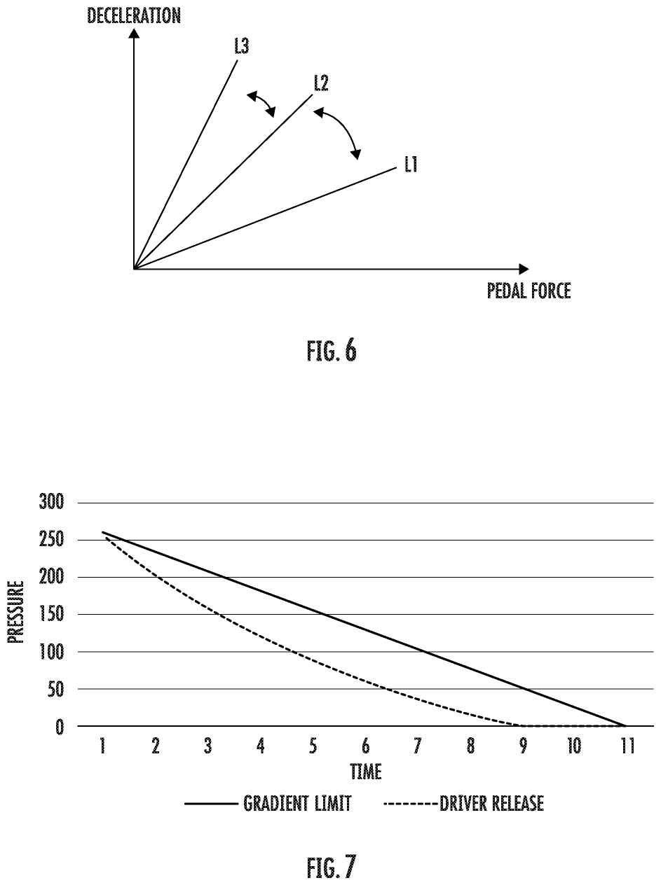

In addition, the assist braking coefficient is adjustable. For example, the assist amplification coefficient can be increased or decreased based on the determined assist braking coefficient. FIG. 6 shows an example of an adjustable power brake coefficient. Referring to FIG. 6, the horizontal coordinate refers to the driver force applied by the driver to the brake pedal (PEDAL FORCE) and the vertical coordinate refers to the vehicle's deceleration; L1-L3 represent the vehicle's decelerations corresponding to different driver forces, where L1 represents vehicle deceleration with driver force alone (i.e., without braking assist); L2 represents vehicle deceleration calculated from the above-mentioned curve of assist amplification; and L3 represents the vehicle deceleration corresponding to another assist amplification coefficient that can be provided based on the braking assist function of the redundant braking system 20 (the “other assist amplification coefficient” can be understood to be the assist amplification coefficient adjusted obtained based on the assist amplification coefficient from the assist amplification coefficient curve). In one example, after calculating the assist amplification coefficient based on the above-mentioned assist amplification coefficient curve, the assist amplification coefficient can be increased (corresponding to the change in vehicle deceleration from L2 to L3) or decreased (corresponding to the change in vehicle deceleration from L2 to L1) based on the actual application scenario.

Continually referring to block 3062, in this example, when the receiving unit 211 receives a signal indicating that a function related to the driving stability of the vehicle is activated, the braking assist unit 213 will maintain the assist amplification coefficient at a value at the moment when the function associated with the stability of the vehicle is activated. Functions related to the stability of the vehicle include, for example, anti-lock function. The signal indicating that the anti-lock function is activated is provided by the anti-lock function module of the redundant braking system. Thus, the receiving unit 211 can receive a signal from the anti-lock function module indicating that the anti-lock function is activated. In this case, the assist amplification coefficient is limited, i.e., to a constant, and when the driver exerts more muscle force on the brake pedal, the braking pressure is still amplified, but only by a fixed ratio (i.e., the ratio at the moment when the function related to the stability of the vehicle is activated).

Referring to block 3063, in one example, when the sensor signal indicates that the driver has released the brake pedal (BP), the braking assist unit 213 determines to execute the second-assist adjustable mode. The situation in which the driver releases the brake pedal can be determined based on a sensor signal indicating that the driver exerts less muscular force on the brake pedal.

In the second-assist adjustable mode, the braking assist operations performed by the braking assist unit 213 include the following steps. First, the driver's desired braking pressure reduction slope is calculated based on the sensor signal. Next, the braking pressure reduction slope actually applied is determined based on the driver's desired braking pressure reduction slope and the braking pressure reduction slope threshold so that the redundant braking system 20 exits the vehicle from braking according to the determined braking pressure reduction slope actually applied. For example, when the driver's desired braking pressure reduction slope causes the braking pressure to drop faster than the braking pressure reduction slope threshold, the actually applied braking pressure reduction slope is determined to be the braking pressure reduction slope threshold. When the driver's desired braking pressure reduction slope causes the braking pressure to decrease slower than the braking pressure reduction slope threshold, the actually applied braking pressure reduction slope is determined to be the driver's desired braking pressure reduction slope.

It is thus advantageous to use the braking pressure reduction slope threshold to limit the speed at which the vehicle exits the brake. For example, if the driver's foot suddenly releases the brake pedal (BP), the driver's desired braking pressure reduction slope will be very large. If the braking pressure reduction slope is not restricted, the brake pedal (BP) will bounce back quickly and hit the driver's foot. By using the braking pressure reduction slope threshold as described above, the rapid rebound of the brake pedal can be avoided.

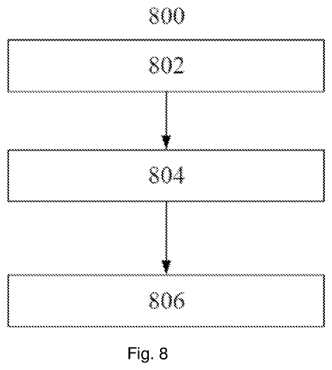

FIG. 7 shows an example of a graph of the braking pressure reduction slope, where the horizontal coordinate refers to the time (TIME), and the vertical ordinate refers to the braking pressure (PRESSURE); the gray curve represents the driver's desired braking pressure reduction slope, and the black curve represents the braking pressure reduction slope threshold. The black curve can be realized as a straight line, i.e., the braking pressure reduction slope threshold can be set to a constant. As shown in FIG. 7, the gray curve is below the black curve, indicating that the driver's desired braking pressure exit rate is significantly faster than the braking pressure exit rate based on the braking pressure reduction slope threshold. Therefore, the vehicle should be exited from braking according to the braking pressure reduction slope threshold (i.e., the black curve).

Referring to block 3064, in one example, in case that the braking assist mode is in the first-assist adjustable mode and the vehicle speed is below the second vehicle speed threshold, a braking pressure holding mode is determined to be executed when a function related to the vehicle's driving stability (e.g., an anti-lock function) is activated. Here, the second vehicle speed threshold is predetermined and should also be understood as a low speed. The second vehicle speed threshold may be the same as the first vehicle speed threshold or be different from it.

In the braking pressure holding mode, the braking assist unit 213 operates the vehicle braking according to a predetermined braking pressure, i.e., the braking pressure is held. The predetermined braking pressure is associated with the braking pressure requested by the function related to the vehicle's driving stability. For example, when the anti-lock function is activated, the function requests a braking pressure of 40 bar, the vehicle braking assist is then performed according to the braking pressure of 40 bar. The holding of the braking pressure can be cancelled when the driver releases the brake pedal or when the function related to the stability of the vehicle is turned off.

This example may be that the vehicle is in the first-assist adjustable mode and the vehicle speed has been reduced to a low level, at which time the anti-lock function is activated, and the braking pressure holding is entered. Once the wheels are found to have recovered, the vehicle will switch from the braking pressure holding mode to the first-assist adjustable mode.

FIG. 8 illustrates a control method 800 for a redundant braking system for a vehicle according to one embodiment of the present disclosure. The method 800 may be performed by the above-described redundant braking system 20 or its electronic control unit 21, so the above description also applies here.

Referring to FIG. 8, in block 802, a status signal indicating the status of the vehicle's main braking system and a sensor signal indicating the driver's input to the brake pedal and the vehicle speed are received.

In block 804, the braking assist function of the redundant braking system is activated when it is determined that the main braking system has entered a mechanical backup state based on the status signal;

In block 806, upon activation of the braking assist function, a corresponding one of a plurality of braking assist modes is determined to be executed based on the sensor signal, wherein the plurality of braking assist modes include: a standby mode, a first-assist adjustable mode, a second-assist adjustable mode, and a braking pressure holding mode.

In block 808, depending on the changes in driver input to the brake pedal and the changes in the vehicle speed, the vehicle switches the braking assist mode among the plurality of braking assist modes.

The present disclosure also provides a machine-readable storage medium storing executable instructions that, when executed, cause one or more processors to perform the method 800 described above.

It should be understood that the processors may be implemented using electronic hardware, computer software, or any combination thereof. Whether these processors are implemented as hardware or software will depend on specific embodiment and the overall design constraints imposed on the system. By way of example, a processor, any portion of a processor, or any combination of processors given in the present disclosure may be implemented as a microprocessor, a microcontroller, a digital signal processor (DSP), a field programmable gate array (FPGA), a programmable logic device (PLD), a state machine, a gate logic, a discrete hardware circuit, and devices configured to perform the various functions described in this present disclosure. Other suitable treatment components. The functions of a processor, any portion of a processor, or any combination of processors given in the present disclosure may be implemented as software executed by a microprocessor, a microcontroller, a DSP, or other suitable platforms.

It should be understood that software should be broadly viewed as representing instructions, instruction sets, codes, code snippets, program codes, programs, subprograms, software modules, applications, software applications, packages, routines, subroutines, objects, running threads, procedures, functions, etc. Software can reside on computer-readable media. The computer-readable media may include, for example, memory. The memory may be, for example, a magnetic storage device (e.g., a hard disk, a floppy disk, a magnetic stripe), an optical disk, a smart card, a flash memory device, a random-access memory (RAM), a read-only memory (ROM), a programmable ROM (PROM), an erasable PROM (EPROM), an electrically erasable PROM (EEPROM), a register, or a removable disk. Although the memory is shown to be separate from the processor in various aspects of the present disclosure, the memory may also be located within the processor (e.g., caches or registers).

Although some embodiments have been described above, these embodiments are given by way of example only and are not intended to limit the scope of the present disclosure. The appended claims and their equivalents substitutions are intended to cover all modifications, substitutions and changes made within the scope and subject matter of the present disclosure.

What is claimed is:

1. An electronic control unit for a redundant vehicle braking system coupled to a main braking system of the vehicle, comprising:
a receiving module configured to receive a status signal indicating a status of the main braking system and a sensor signal indicating a driver input condition to the brake pedal and a vehicle speed condition;
an activation module configured to activate the braking assist function of the redundant braking system when it is judged that the main braking system has entered a mechanical backup state based on the status signal; and
a braking assist module storing a plurality of braking assist modes for implementing the braking assist function, the braking assist module configured to execute a corresponding one of said plurality of braking assist modes based on the sensor signal after the braking assist function is activated, and the braking assist module further configured to switch between a plurality of braking assist modes according in response to changes in brake pedal input conditions and changes in vehicle speed, wherein the plurality of braking assist modes comprises a standby mode, a first-assist adjustable mode, a second-assist adjustable mode, and a braking pressure holding mode.

2. The electronic control unit according to claim 1, wherein the activation module is further configured to not activate the braking assist function of the redundant braking system when at least one of the following conditions is satisfied:
it is determined that the braking assist function of the main braking system is operating normally based on the status signal; and
the vehicle speed is below a first vehicle speed threshold.

3. The electronic control unit according to claim 1, wherein:
based on the sensor signal, a corresponding one of a plurality of braking assist modes determined to be executed comprises: when the sensor signal indicates that the driver has no input to the brake pedal, the standby mode is determined to be executed, in which the braking assist module does not perform any braking assist operations.

4. The electronic control unit according to claim 1, wherein:
the corresponding one of a plurality of braking assist modes determined to be executed based on the sensor signal comprises: when the sensor signal indicates that the driver depresses the brake pedal, it is determined to execute the first-assist adjustable mode, and
in the first-assist adjustable mode, the braking assist module is configured to:
calculate the desired braking pressure of the driver based on the sensor signal; and
adopt the amplification coefficient curve to determine the assist amplification coefficient corresponding to the desired braking pressure of the driver so that the redundant braking system can control the braking of the vehicle according to the determined assist amplification coefficient, wherein the amplification coefficient curve is predetermined and contains the correspondence between the driver's desired braking pressure and the assist amplification coefficient.

5. The electronic control unit according to claim 4, wherein:
in the first-assist adjustable mode, the braking assist module is further configured to maintain the assist amplification coefficient at a value at the moment when the function associated with the driving stability of the vehicle is activated in case that the receiving unit receives a signal indicating that the function associated with the running stability of the vehicle is activated.

6. The electronic control unit according to claim 1, wherein:
the corresponding one of a plurality of braking assist modes determined to be executed based on the sensor signal comprises when the sensor signal indicates that the driver releases the brake pedal, the second-assist adjustable mode is determined to be executed, and
in the second-assist adjustable mode, the braking assist module is configured to:
calculate the driver's desired braking pressure reduction slope based on the sensor signal; and
determine the actual applied braking pressure reduction slope based on the driver's desired braking pressure reduction slope and braking pressure reduction slope threshold so that the redundant braking system exits the vehicle from braking according to the determined and actually-applied braking pressure reduction slope.

7. The electronic control unit according to claim 6, wherein the braking pressure reduction slope determined and actually applied based on the driver's desired braking pressure reduction slope and the braking pressure reduction slope threshold comprises:
when the driver's desired braking pressure reduction slope reduces the braking pressure faster than the braking pressure reduction slope threshold, the actually applied braking pressure reduction slope is determined as the braking pressure reduction slope threshold; and
when the driver's desired braking pressure reduction slope reduces the braking pressure slower than the braking pressure reduction slope threshold, the actually applied braking pressure reduction slope is determined as the driver's desired braking pressure reduction slope.

8. The electronic control unit according to claim 1, wherein:
the corresponding one of a plurality of braking assist modes determined to be executed based on the sensor signal comprises: in case that the braking assist mode is in the first-assist adjustable mode and the vehicle speed is lower than the second vehicle speed threshold, when the function related to the driving stability of the vehicle is activated, the braking pressure holding mode is determined to be executed, and
in the braking pressure holding mode, the braking assist module is configured to control the redundant braking system to perform vehicle braking at a predetermined braking pressure.

9. The braking assist control unit according to claim 1, wherein the braking assist unit comprises a braking assist model, the braking assist model including the plurality of braking assist modes and switching states therebetween, the switching states corresponding to changes in driver input to the brake pedal and changes in vehicle speed.

10. The braking assist control unit according to claim 9, wherein the switching states comprise:
two-way switching between the first-assist adjustable mode and the standby mode, the second-assist adjustable mode and the braking pressure holding mode respectively;
one-way switching from the braking pressure holding mode to the standby mode;
one-way switching from the braking pressure holding mode to the second-assist adjustable mode; and
one-way switching from the second-assist adjustable mode to the standby mode.

11. A redundant braking system for a vehicle, comprising:
two brake circuits configured to fluidly interact with two brake circuits of the vehicle's main braking system respectively;
four valves connected between the main brake cylinder of the main braking system and the four brake wheel cylinders of the vehicle;
a motor configured to generate braking assist for pumping brake fluid in the main brake cylinder into part or all of the four brake wheel cylinders; and
an electronic control unit, according to claim 1, electrically operating the four valves and the motor, and performing the braking assist function when the main braking system enters a mechanical backup state.

12. A method of controlling a redundant braking system for a vehicle, the method being performed by an electronic control unit according to claim 1, the method comprising:
receiving a status signal indicating a status of the main braking system of the vehicle and a sensor signal indicating a driver input condition to the brake pedal and a vehicle speed condition;
activating the braking assist function of the redundant braking system when determining that the main braking system is in a mechanical backup state based on the status signal;
determining to execute a corresponding one of a plurality of braking assist modes based on the sensor signal after the braking assist function is activated; and
switching the braking assist mode among the plurality of braking assist modes according to the changes in the driver's input to the brake pedal and the changes in the vehicle speed,
wherein the plurality of braking assist modes include: a standby mode, a first-assist adjustable mode, a second-assist adjustable mode, and a braking pressure holding mode.

13. A machine-readable storage medium storing executable instructions that, when executed, cause one or more processors to perform the control method of claim 12.

14. The electronic control unit according to claim 1, wherein the activation module is further configured to not activate the braking assist function of the redundant braking system when at least one of the following conditions is satisfied:
it is determined that the braking assist function of the main braking system is operating normally based on the status signal; and
the vehicle speed is below a first vehicle speed threshold, the first vehicle speed threshold being the creeping speed of the vehicle.
